(19) United States
(12) Patent Application Publication
(10) Pub. No.: US 2006/0016316 A1
(43) Pub. Date: Jan. 26, 2006

(54) Method and apparatus for forming foldable structures

(76) Inventors: Major L. Madon, Mapleton, UT (US); Heather Lancaster, Calgary (CA)

Correspondence Address: MORRISS O'BRYANT COMPAGNI, P.C., 136 SOUTH MAIN STREET, SUITE 700, SALT LAKE CITY, UT, 84101, US

(21) Appl. No.: 11/183,553

(22) Filed: Jul. 18, 2005

Related U.S. Application Data
(60) Provisional application No. 60/588,588, filed on Jul. 16, 2004.

(51) Int. Cl. B26D 3/08; B31B 1/25

(52) U.S. Cl. 83/879; 83/880

(57) ABSTRACT

An apparatus for forming various three dimensional objects, such as various shapes and sizes of boxes, is provided. The apparatus includes a cutting tool, a scoring tool and a template. The template is provided with various channels for guiding the cutting and scoring tools. After all of the selected cutting and scoring procedures have occurred, the material that has been cut and scored is folded along the scored sections in order to form a three-dimensional object.

### CROSS REFERENCE

This application claims priority to U.S. Provisional Application No. 60/588,588 filed on Jul. 16, 2004.

### BACKGROUND

1. Field of the Invention

The invention relates to cutting and folding material into selected shapes. More specifically, the invention relates to templates for guiding cutting and scoring instruments for selectively cutting and scoring selected materials so as to produce selected shapes.

Description of the Art

Many hobbies and professions involve sizing or shaping materials. Particularly in the craft and scrapbooking industry, photographs and other sheets of material, such as paper, are cut into select shapes for placing and displaying in albums. For example, preparing photographs for display typically includes mounting a photograph on a substrate, and then overlying the photograph with a mat having a shaped aperture so that the mat frames and enhances the photograph. Conversely the mat can be mounted under the photograph and the photograph mounted on the mat, with the protruding beyond the edges of the photograph to obtain a similar look.

Cutting a shaped aperture in a medium is accomplished in many different ways. For example, a shape may be drawn on the medium and subsequently traced with a cutting tool. The shape also may be drawn on a separate piece of material which is then cut out and applied to the medium to be cut. An appropriately sized and shaped aperture or mat also may be located on material according to a template having appropriate apertures which may be traced and subsequently incised. Also to avoid the inconvenience of maintaining a collection of templates having different aperture shapes and sizes, some templates may provide interchangeable modules. See, for example, U.S. Pat. No. 5,531,176, issued Jul. 2, 1996, to A. M. Johnson, U.S. Pat. No. 5,860,219, issued Jan. 19, 1999, to C. E. Wilkinson, and U.S. Pat. No. 5,613,811, issued Mar. 25, 1997, to G. M. Tillemans.

The use of a template for use as a cutting guide is not new. For example, U.S. Pat. No. 5,865,928, issued Feb. 2, 1999, to R. L. Lariviere, Jr. et al, describes custom cutting photographs and other graphic materials into interlocking puzzle shapes to construct a collage-puzzle. The template disclosed by Lariviere et al. has channels which guide a blade so as to cut a desired medium, such as a photograph into puzzle pieces of different predetermined shapes.

Such cutting templates, however, have been limited to the cutting of particular two dimensional shapes, e.g., circles, ovals, squares, rectangles, stars, hearts, etc., to be used as a background or frame for a photograph or other graphical image or design. It would be advantageous, however, to provide templates that are configured to provide channels for guiding a cutting or scoring tool over a medium in order to create three-dimensional objects that are folded into a particular shape. It would be a further advantage to provide a scoring tool that is interchangeable with a cutting tool and that is usable with a template for scoring a medium in order to create a precise fold at the location where the medium has been scored.

These and other advantages will become apparent from a reading of the following summary of the invention and description of the illustrated embodiments in accordance with the principles of the present invention.

### SUMMARY OF THE INVENTION

Accordingly, an apparatus for forming various three dimensional objects, such as various shapes and sizes of boxes, is provided. The apparatus includes a cutting tool, a scoring tool and a template. The template is provided with various channels for guiding the cutting and scoring tools. After all of the selected cutting and scoring procedures have occurred, the material that has been cut and scored is folded along the scored sections in order to form a three-dimensional object.

In one embodiment, the scoring tool is comprised of an elongate handle having a removable cap attached to a distal end thereof. A scoring member is rotatably coupled to the handle with the cap. The scoring member protrudes through the cap to be received within a channel of a complementary template.

In another embodiment, the scoring tool is configured to be converted into a cutting tool by removing an end cap, replacing the scoring member with a cutting member and reattaching the end cap.

In yet another embodiment, the scoring tool is used in conjunction with a template, the template having a first set of channels for cutting a particular shape and a second set of channels for scoring and creating folds, the template configured to provide channels for scoring and cutting a sheet of material to create a three-dimensional object.

In still another embodiment, the template is configured to create a particularly shaped box when folded along the lines that have been scored through the template.

In another embodiment, the template includes markings to indicate which channels should be cut and which channels should be scored.

The foregoing summary, as well as the following detailed description of the preferred embodiments is better understood when read in conjunction with the appended drawings. For the purpose of illustrating the invention, there is shown in the drawings embodiments that illustrate what is currently considered to be the best mode for carrying out the invention, it being understood, however, that the invention is not limited to the specific methods and instruments disclosed.

### BRIEF DESCRIPTION OF THE DRAWINGS

FIG. 1 is a partial cross-sectional, exploded side view of a first embodiment of a scoring tool in accordance with the principles of the present invention.

FIG. 2 is a side view of the scoring tool illustrated in FIG. 1 in assembled form.

FIG. 3 is a side view of a first embodiment of a scoring tool cartridge in accordance with principles of the present invention.

FIG. 4 is a distal end view of the scoring tool illustrated in FIG. 2.

FIG. 5 is a proximal end view of the scoring tool illustrated in FIG. 2.

FIG. 6A is a side view of a scoring member in accordance with the principles of the present invention.

FIG. 6B is a distal end view of the scoring member illustrated in FIG. 6A.

FIG. 7 is a side view of a cutting cartridge in accordance with the principles of the present invention.

FIGS. 8A, 8B and 8C are front side, right side and top side views, respectively, of a first embodiment of a scoring/cutting template in accordance with the principles of the present invention.

FIG. 9 is a front side view of a second embodiment of a scoring/cutting template in accordance with the principles of the present invention.

FIG. 10 is a front side view of a second embodiment of a scoring/cutting template in accordance with the principles of the present invention.

FIG. 11 is a front side view of a pocket formed using the template illustrated in FIG. 10.

FIG. 12 is a front side view of a third embodiment of a scoring/cutting template in accordance with the principles of the present invention.

FIG. 13 is a front side view of a box formed using the template illustrated in FIG. 12.

FIG. 14 is a front side view of a fifth embodiment of a scoring/cutting template in accordance with the principles of the present invention.

FIG. 15 is a front side view of a sixth embodiment of a scoring/cutting template in accordance with the principles of the present invention.

FIG. 16 is a front side view of a seventh embodiment of a scoring/cutting template in accordance with the principles of the present invention.

FIG. 17 is a front side view of an eight embodiment of a scoring/cutting template in accordance with the principles of the present invention.

FIG. 18 is a front side view of a ninth embodiment of a scoring/cutting template in accordance with the principles of the present invention.

FIG. 19 is a front side view of a tenth embodiment of a scoring/cutting template in accordance with the principles of the present invention.

FIG. 20 is a front side view of an eleventh embodiment of a scoring/cutting template in accordance with the principles of the present invention.

FIG. 21 is a front side view of a twelfth embodiment of a scoring/cutting template in accordance with the principles of the present invention.

### DETAILED DESCRIPTION OF THE ILLUSTRATED EMBODIMENTS

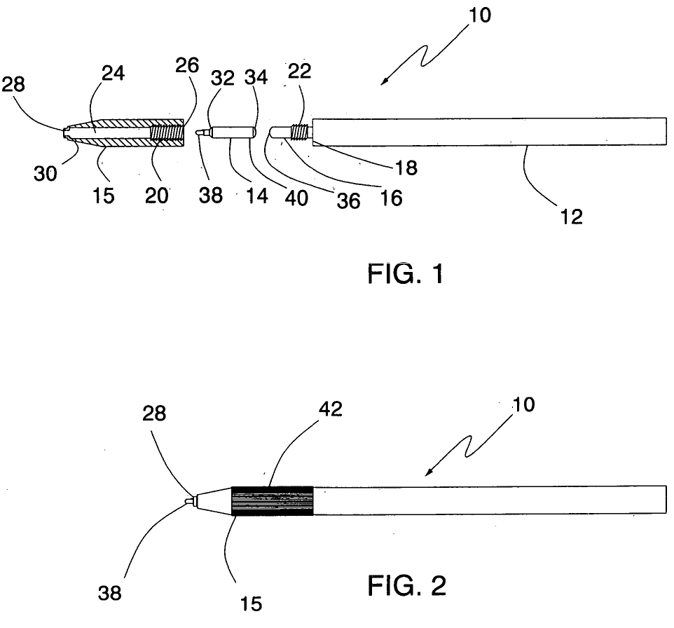

Referring to the drawings wherein like numerals indicate like elements throughout, there is shown in FIG. 1, an exploded view of a scoring tool, generally indicated at 10, in accordance with the principles of the present invention. The coring tool 10 generally has the size and configuration of a conventional ball-point pen for grasping by a user and includes an elongate handle or base member 12 for grasping by a user to which a scoring cartridge 14 is maintained. The scoring cartridge 14 is held relative to the base member 12 with a retaining member 15 that is coupled to the base member 12. The base member 12 is provided with a partially threaded protrusion 16 at its distal end 18. The cap or retaining member is provided with internal threads 20 for mating with external threads 22 formed on the protrusion 16 and for receiving the protrusion 16 therein.

The retaining member 15 is provided with a longitudinal bore 24 that extends the length of the retaining member 15 with the proximal end 26 of the bore 24 being threaded and the distal end 28 provided with an annular abutment surface 30. The distal end 28 is cylindrical in shape so as to be received within and guided by a channel of a complementary template shown and described herein. The cylindrical distal end 28 of the retaining member 15 thus has a width that is slightly less than but substantially equal to the width of a channel of a complementary template. The scoring cartridge 14 is maintained between the protrusion 16 and the abutment surface 30 with the engagement of an annular shoulder 32 and the abutment surface 30 preventing the scoring cartridge from falling out of the retaining member 15.

The scoring cartridge is configured to be freely rotatable within the retaining member 15. In order to facilitate such free rotation, substantial point contact between the proximal end 34 of the cartridge 14 and the distal end 36 of the protrusion is provided. This point contact is accomplished by providing semispherical ends to both the proximal end 34 of the scoring cartridge 14 and the distal end 36 of the protrusion 16.

The scoring cartridge 14 is comprised of a scoring member 38 and a body 40 that holds the scoring member 38 relative thereto.

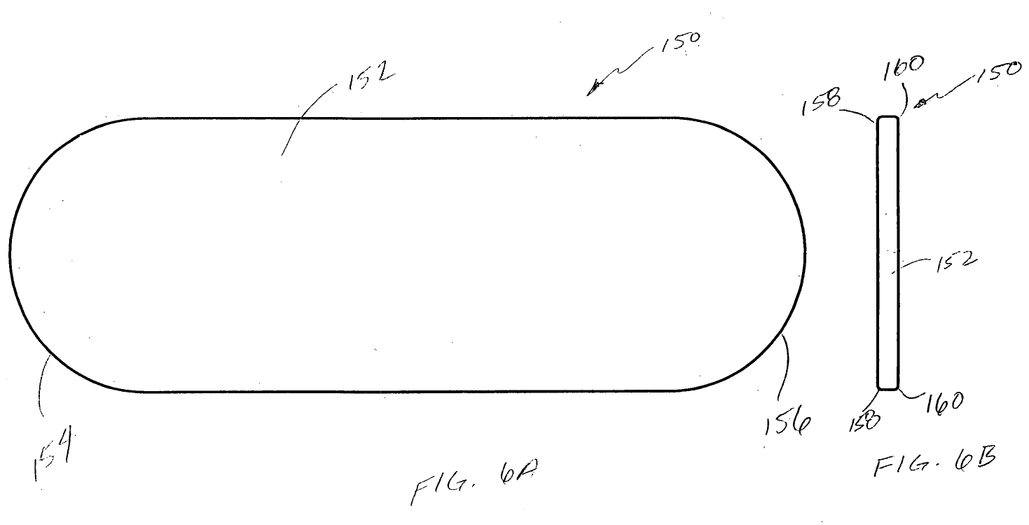

When assembled, as shown in FIG. 2, the scoring tool 10 is grasped by a user between the thumb, index finger and middle finger in a manner similar to holding a pen at the retaining member 15. The retaining member 15 is provided with longitudinally extending grooves 42 that are circumferentially placed around the retaining member 15 (see FIG. 4). Such grooves 42 provide a gripping surface for the user to prevent slipping from the tool 10 when using the tool 10 to score a material. The scoring member 38 extends from the distal end 28 of the retaining member 15 and can freely rotate along its longitudinal axis relative thereto. As shown in FIG. 5, the proximal end 44 of the base member 12 is generally circular in shape. Thus, the base member 12 is generally illustrated as being cylindrical in shape, but could have any geometric shape, such as octagonal, hexagaonal, square, triangular, or any other desired shape.

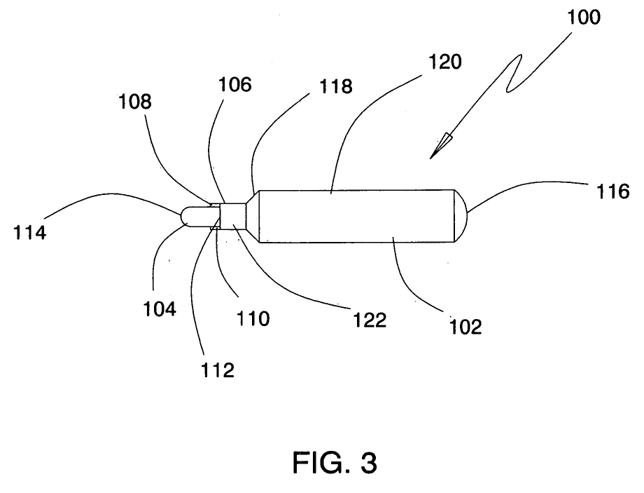

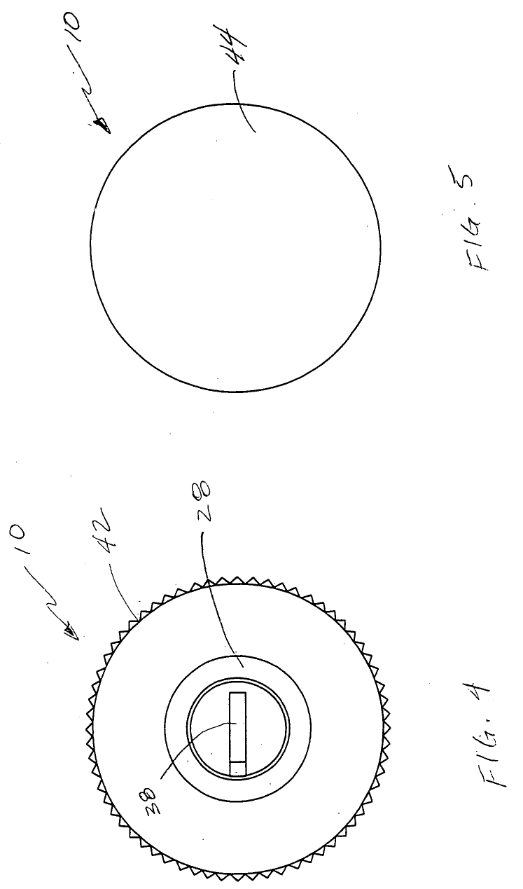

Referring now to FIG. 3, there is shown a scoring cartridge, generally indicated at 100, in accordance with the principles of the present invention. The scoring cartridge 100 includes a body 102 and a scoring member 104 attached to a distal end 106 thereof. Because the scoring member 104 is to be inserted within a channel of a template (as described hereinafter), guiding protrusions 108 and 110 are provided on the two leading edges of the scoring member 104. Unlike a pivoting knife blade which typically only has one cutting edge, because of the symmetrical nature of the scoring member 104, the scoring member 104 can be used in either direction. Thus, guiding protrusions 108 and 110 are provided on both leading edges of the scoring member 104. When inserted into a channel of a template, the scoring member 104 will be positioned within the channel up to the distal end 106 of the body 103. Thus, the guiding protrusions 108 and 110 have a length that is long enough to engage the template channel and prevent the scoring member 104 from gouging or otherwise damaging the side walls of the channel. As shown, the guiding protrusions 108 and 110 have a length that exposes at least the rounded end 114 of the scoring member 104 beyond the protrusions 106 and 110 so as to allow the rounded end 114 to engage a surface to be scored.

The scoring member 104 is formed from metal, such as steel, while the body 102 is formed from plastic. The body 102 may be injection molded or otherwise molded or formed by methods known in the art. The scoring member 104 is inserted into the distal end 112 of the body 102 so that a portion of the scoring member 104 protrudes from the distal end 112. As such, a portion (not visible) of the scoring member 104 is encased within the body 102 to secure the scoring member 104 within the base member 102. The scoring member 112 may be held within the distal end 112 of the base member by molding the scoring member 104 into the base member 102 when forming and/or by friction fit between the scoring member 104 and the body 102.

The body 102 of the scoring cartridge 100 is generally cylindrical in shape to allow the body 102 to freely rotate within its housing or retaining member as previously shown and discussed. That is, the diameter of the body 102 is slightly less than the inside diameter of the retaining member to allow the scoring cartridge 100 to rotate therein. In addition, the proximal end 116 of the body 102 is substantially semispherical in shape to provide point contact with structure that maintains the scoring cartridge 100. The body 102 also defines a frustoconical surface 118 that can abut the inside of the retaining member to prevent the scoring cartridge 100 from falling out of the retaining member. The frustoconical surface 118 provides a transition between the body main portion 120 of the body 102 and the more narrow portion 122 at the distal end 112 that holds the scoring member 114.

As shown in FIGS. 6A and 6B, a scoring member, generally indicated at 150, is formed from a flat piece of metal 152, such as CL095 carbon steel, with radiused ends 154 and 156. The scoring member 150 may have an overall length of approximately 0.1962 inches with each end 154 and 156 having a radius of 0.031 inches. The width of the scoring member 150 may be approximately 0.0652 inches with a thickness of approximately 0.012 inches. The edges 158 and 160 of the scoring member 150 are also slightly radiused, e.g., 0.003 inches, in order to prevent the scoring member 150 from cutting the medium that is being scored. That is, by providing a slight radius to the edges 158 and 160 of the scoring member 150, the scoring member 152 will slide along the medium to cause a crease therein without cutting the material.

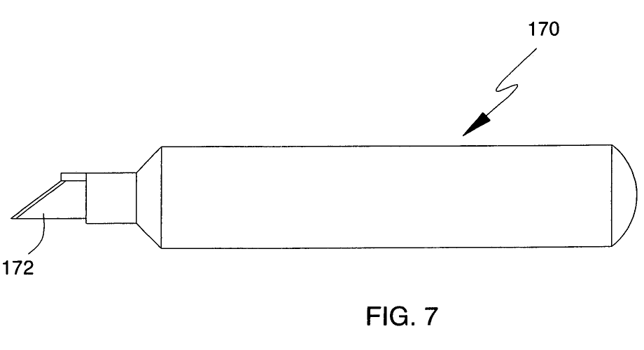

As shown in FIG. 7, a cutting cartridge, generally indicated at 170, has the same general configuration as the scoring cartridge described herein. The principle difference is that the cutting cartridge 170 is provided with a cutting blade 170 for cutting a medium. Because of the configuration of the base member and retaining member illustrated in FIG. 1, the cutting and scoring cartridges can be interchanged if desired. In addition, when the cartridges become worn from use, the cartridges can be easily replaced with new ones.

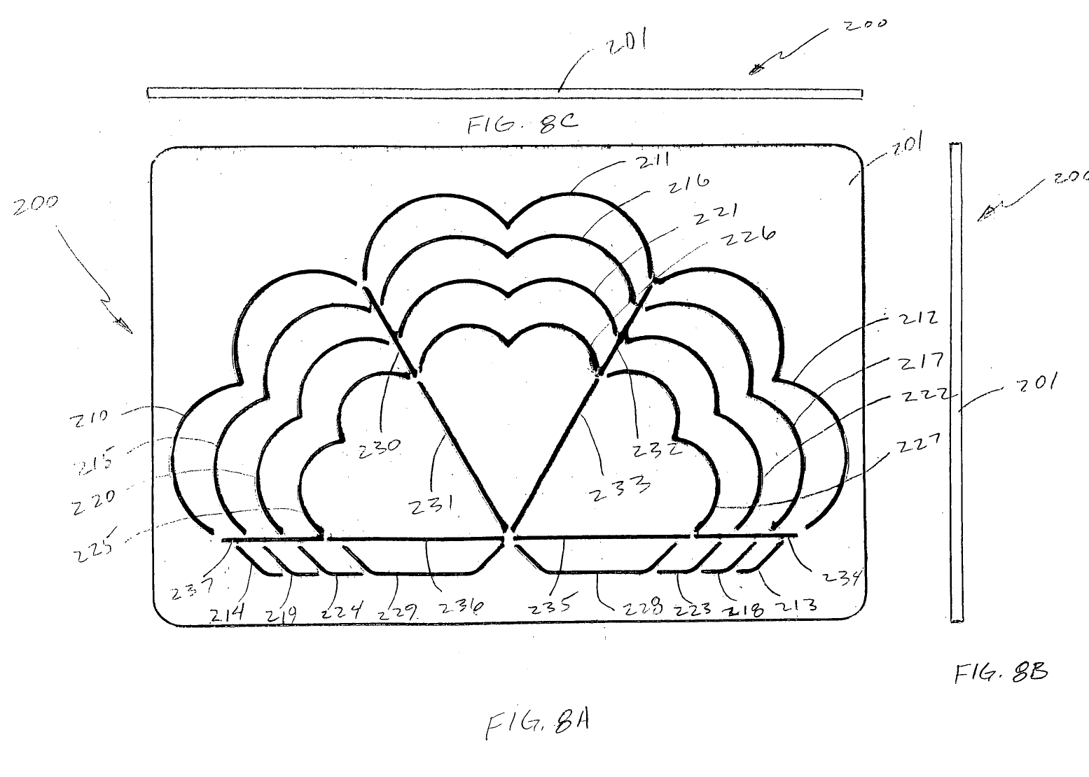

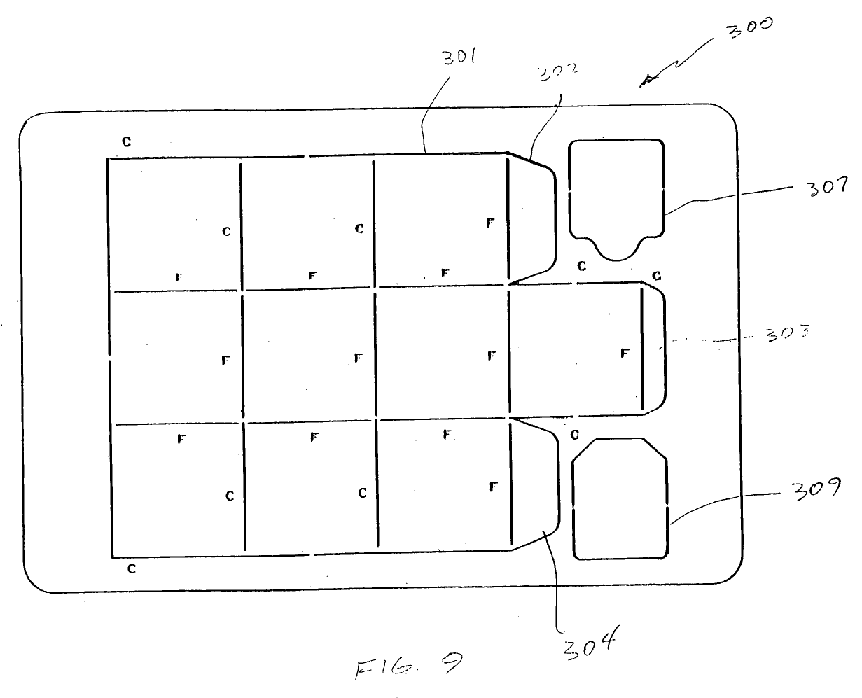

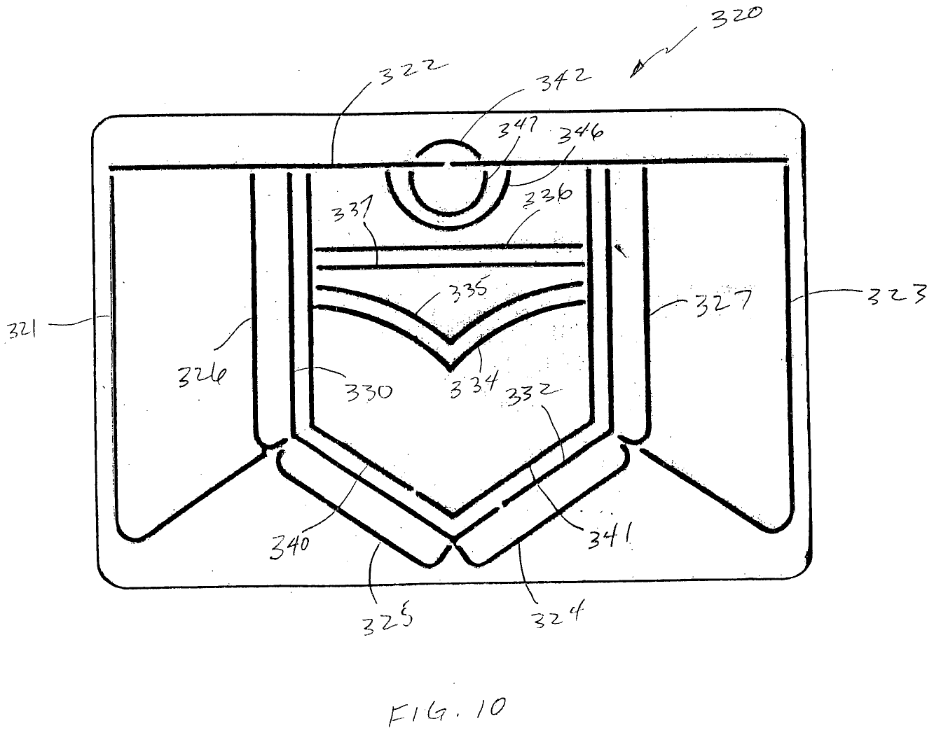

Referring now to FIGS. 8A, 8B and 8C, there is shown a first embodiment of a template, generally indicated at 200, for forming a three-dimensional folded object, in this case, a heart-shaped card or box. The cutting and scoring template 200 provides a plurality of channels that extend through the template for precisely cutting and scoring a selected medium in sheet form so as to produce similar shapes in multiple sizes, or diverse shapes. The nature of the medium that is used may vary according to the intended purpose. By way of example, the medium may take the form of a sheet of paper, cardstock, cardboard, conventional graphic arts matting material, thin plastic, foam or a fabric. The medium may be white or colored and may be blank or printed, comprising, for example, a graphic arts object such as a photograph, print, drawing, or printed text. In-practicing the invention, the medium is mounted or placed on a cutting surface, such as sheet of cardboard, plastic foam or other cutting mat, a template embodying the invention is placed flat on top of the medium. Thereafter, the cutting blade of a cutting tool is inserted in a selected channel of the template and then moved along the channel so as to cut the medium at the select locations to form a shape conforming to the pattern defined by the channels in the template. Because the blade cartridge can freely swivel within the handle, the blade will follow the template channel as the knife blade is moved along.

The template 200 consists of a sheet or panel 201 that is made of a transparent material, although it also may be made of a semi-translucent or opaque material. The transparency or translucency of the sheet 201 allows for viewing and/or aligning a selected medium prior to cutting it with a selected cutting tool. The template 200 is intended to be reusable. Therefore, by way of example but not limitation, the template 200 may be constructed from a material that is relatively inexpensive, resists wear, and which allows cutting or formation of the channels hereinafter described such as a polycarbonate or a polyacrylate material, although a polyethylene template having adequate transparency also may be used.

The specific template 200 shown in FIGS. 8A, 8B and 8C comprises a plurality of channels or grooves 210-237 with the grooves 210-229 having widths sized to accept the thin cutting blade of a cutting tool and the grooves 230-237 having widths sized to accept the thin scoring blade, such as the-scoring blade of the scoring tool 10 shown in FIG. 2, so that the blades make a close sliding fit in whatever-channel they are inserted. The cutting tool preferably is constructed so that the thin cutting blade is rotatable on the cutting tool's axis, as explained in U.S. Pat. No. 5,865,928.

The cutting channels 210-229 in template 200 constitute four sets of channels for forming four different sizes by similarly shaped structures cut into a medium. Thus, a user can select one of four sizes when making a heart-shaped box or card from a medium cut using the template 201.

In this particular embodiment, the template 200 can be used to make four sizes of tri-fold heart cards or boxes. First, the outer channels of the chosen size heart shape are cut as well as the corresponding bottom channels (e.g., channels 210, 211, 212, 213 and 214 and outer channel portions of channels 218, 223, 228, 229, 224, and 219. The scoring channels 230-237 separate the three hart shapes. By inserting the scoring tool 10 into the channels 230, 231, 232, 233, 234, 235, 236, and 237 and sliding the scoring member within each channel, a crease is formed in the medium. In order to properly score the-medium, the medium and the template 201 should be placed on a relatively rigid surface. The scoring tool 10 is then firmly presses within the selected channel so as to crease the medium.

Because the channels are spaced by small webs of the template material in order to maintain the template in a single piece, some cutting or scoring at the web locations of the medium may be required. More specifically, certain channels are separated by webs of template material. If the cutting blade is drawn along a selected channel that is interrupted by a particular web, the medium will have an incision that is interrupted by a section corresponding to the template web. Consequently, to complete formation of a complete incision in medium, the user must remove the template from engagement with the medium, and then cut the uninterrupted portions of the medium between the two incisions that correspond to web so that the two incisions are joined.

The width of the template webs are set so that the webs have sufficient expanse to maintain the template's physical integrity, while at the same time minimizing the amount of medium that has to be cut after removal of the template to completely reproduce the selected circular pattern or shape in the medium. Such webs, however, have little effect on the scoring operation. That is, a small uninterrupted section in the score will not prevent the medium from being properly folded along the two interrupted scores spaced apart by the width of the web.

The bottom channels, such as channels 229 and 228 provide tabs in the medium that are used to hold the structure together once formed. For example, by applying an adhesive to the tabs, they can be attached relative to one another and or to other portions of the cut medium in order for the three-dimensional structure to hold its shape.

Referring now to FIG. 9, there is illustrated another embodiment of a template, generally indicated at 300, for forming a box from a desired medium in sheet form. The template 300 is provided with a plurality of channels, such as channel 301, with each channel provided with an indicating label, in this embodiment being designated with an “F” for fold or a “C” for cut. When all of the cut and fold procedures are complete as indicated by the template 300, the resulting medium can be folded along the sections that have been scored with the scoring tool. The tabs 302, 303 and 304 are used to secure the box together once folded. For example, an adhesive or tape may be applied to the tab portions and secured to their respective mating surfaces on the medium that has been cut when folded.

The template 300 also includes tags 307 and 309 that can be cut into a desired medium and be used to place on the box when completed.

The channels 301 in the template 300 are intended to guide the cutting and scoring blades so as to ensure that the patterns defined by the channels 301 will be reproduced with precision in the selected medium. In this regard the term “guide” is intended to mean that opposite sides of the particular blade lie close to and are slidingly supported by the opposite side surfaces of the grooves that constitute the several cutting channels. To ensure proper guidance, it is preferred that the grooves be formed with flat opposite side surfaces that extend perpendicular to the flat faces of template panel, and that they have a width such as to provide a clearance in the range of 0.002 and 0.007 inch between each side of the channel and the adjacent face of the inserted blade. It is preferred that the blade have a thickness in the range of 0.011 inch to 0.013 inch. Consequently it is preferred that the channels have a thickness of 0.015 inch to 0.018 inch. However, it should be appreciated that blade thickness, the widths of the grooves and the magnitude of the clearances for the cutting and/or scoring blade are not limited to the foregoing values, but rather other values may be acceptable so long as they assure precision cutting and scoring of a selected pattern in a medium.

To use the template 300 for cutting a medium, a medium is positioned on a cutting mat. The template 300 is positioned over the medium at the desired location. The medium should be large enough to extend beyond the cutting channels on all sides. A swivel knife, such as that shown in FIG. 2, with the knife cartridge shown in FIG. 7, is held at the textured area of the handle. The tip of the blade is inserted at the beginning of a channel to be cut with the cutting edge facing towards the cutting direction. Holding the swivel knife in an upright position and pressing firmly against the template, the swivel knife is firmly glided along the channel to the end of the channel, letting the blade steer itself around corners and curves. Once all of the cutting functions have been completed, the cutting mat is removed and the medium and template are repositioned on a firmer surface for the scoring procedure. Grasping the textured area of the handle of a swivel scoring tool, such as that illustrated in FIG. 2, the tip of the scoring member is inserted at the beginning of a channel to be scored. Holding the scoring tool at an angle of approximately 45 degrees, and pressing firmly against the template, the scoring tool is firmly glided along the channel to the end of the channel, letting the blade steer itself around corners and curves. Once all of the scoring functions are complete, the medium can be folded along each score to form the particular three-dimensional structure, in the case of FIG. 9, a cube-shaped box.

FIG. 10 illustrates yet another embodiment of a template, generally indicated at 320 for forming a foldable three-dimensional structure in accordance with the principles of the-present invention. Using the template 320, a card pocket can be formed having the general shape of a shirt or pant pocket. The template 320 can be used to form one of two pockets. By cutting the channels 321-325, a fully enclosed pocket can be formed with both front and back sides. By cutting channels 324-327 and the corresponding portion of channel 322 extending between the tops of channels 326 and 327, a pocket that can be glued or otherwise attached to a scrapbook page or other medium can be formed. Once cut, the medium can be folded along channels 330 and 332 by gliding the scoring tool 10 (see FIG. 2) along the channels 330 and 332.

If desired, decorative “stitch” lines can be formed by cutting along one or more of the channels 334-337. Furthermore, channels 340 and 341, along with the appropriate length of channel 322 between the top ends of channels 340 and 340 to form a card that will fit within the pocket once formed. A half circle pull tab can be added to the card by cutting the half circle channel 342 at the top of the card rather than cutting straight across with the channel 342. The half circle channels 346 or 347 can be cut into the front of the pocket so that it is easier to grab the card out of the pocket.

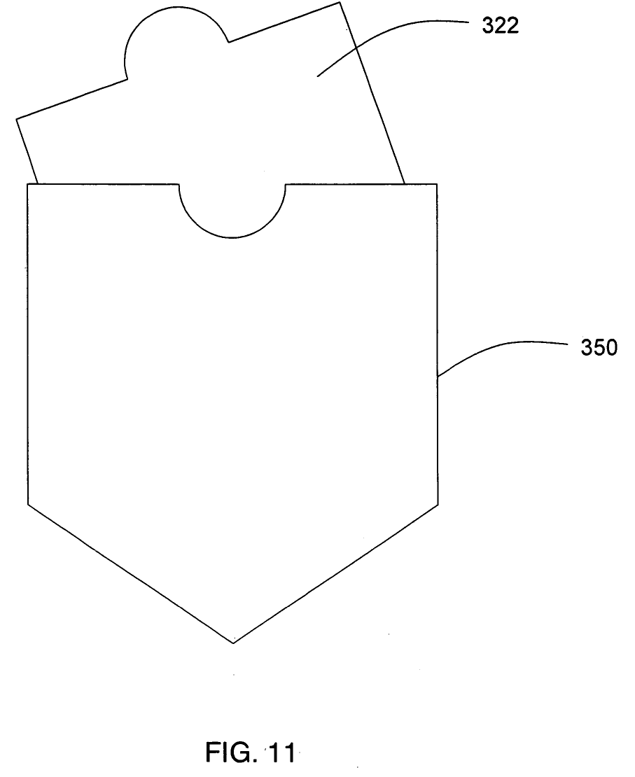

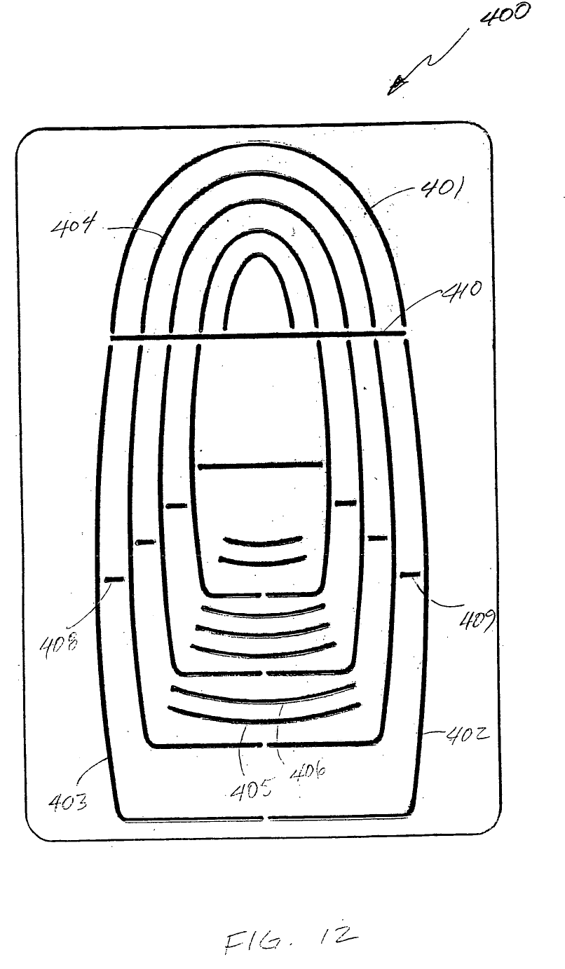

FIG. 11 shows a pocket 350 formed from a material that has been cut and scored by using the template 320. A card 322 formed by cutting along the channels of the template 320 is inserted into the pocket 350.

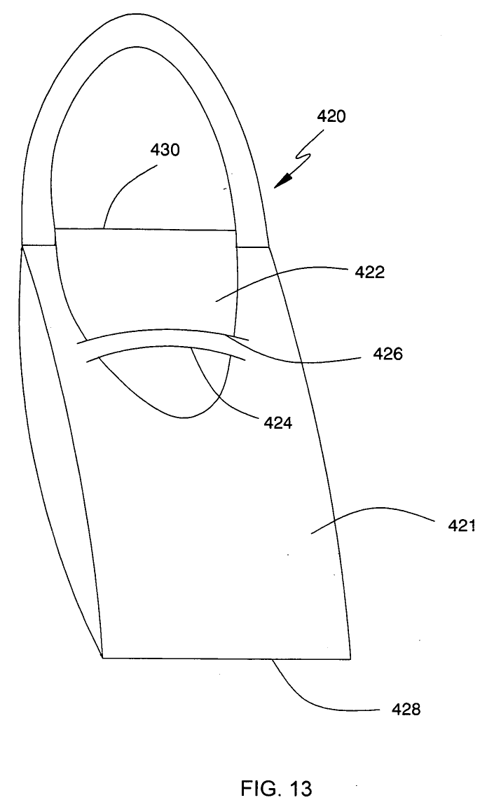

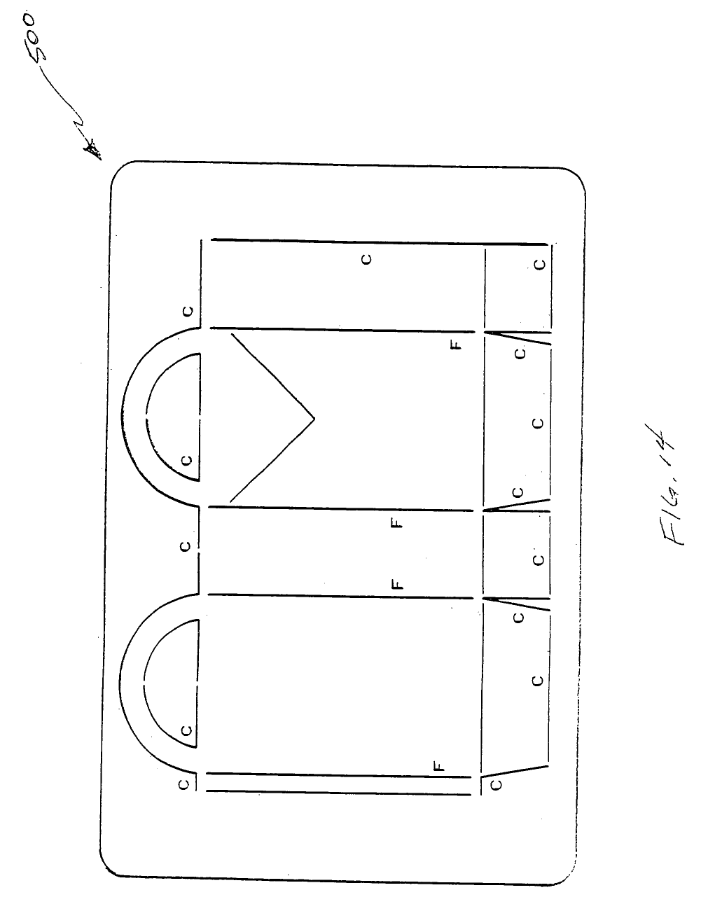

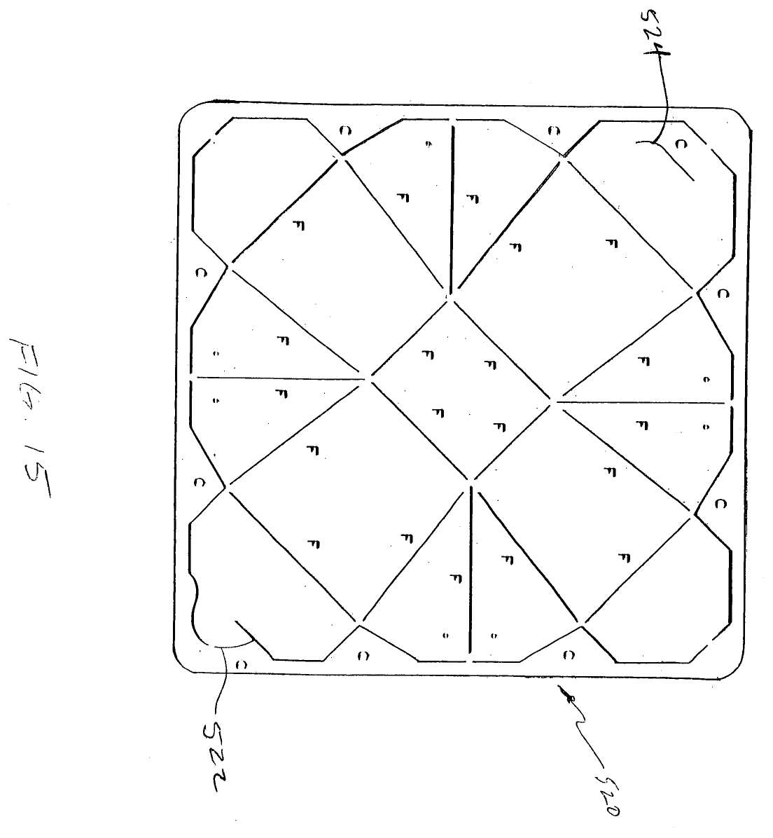

FIG. 12 illustrates yet another template, generally indicated at 400, for forming a three-dimensional purse-shaped card (see FIG. 13). The template 400 can be used to form four different sized purse cards depending upon the channels used to cut. To form a purse card, the channels representing the outer size of the desired purse card are selected. Thus, for the largest purse card, the channels 401, 402 and 403 are cut. Next, the purse handle is formed by cutting long the channel 404 that is one size smaller from the purse size. The flap that is formed from the inside of the handle will fold down and become the closure for the purse card. Curved channels 405 and 406 are cut to allow the flap to be tucked and held in place. The curved channels 405 and 406 are also selected to correspond to the particular purse size. Next, by scoring with the scoring tool along channels 408, 409, and 410, the purse can be folded into the finished shape.

FIG. 13 illustrates a purse card 420 formed from the template 400. As previously described, the flap-422 fits within the curved cuts 424 and 426 and holds the card 420 together. Folds 428 and 430 are precisely formed by gliding the scoring tool along channel 410 of FIG. 12 at the appropriate location. That is, the channel 410 can be moved over the appropriate location on the medium 421 to form a crease at a desired location for folding.

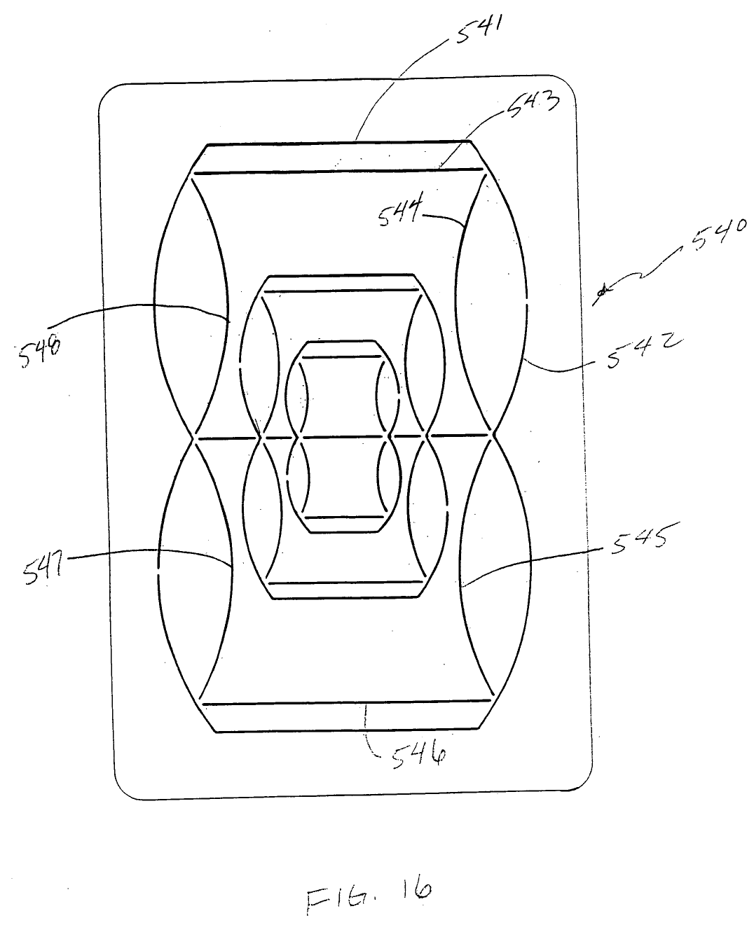

FIGS. 14-22 illustrate various other templates that can be used with the scoring and cutting tools of the present invention in order to form foldable three-dimensional objects in accordance with the present invention.

FIG. 14 is a template, generally indicated at 500, for forming a handled box. Each of the channels for cutting is designated with a “C” and each of the channels for scoring with the scoring tool is indicated with an “F” for fold.

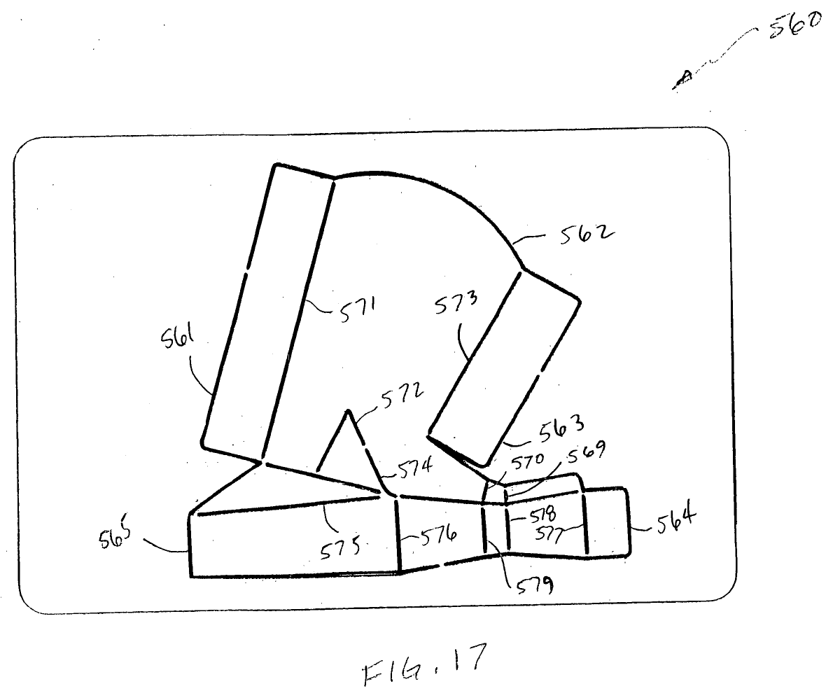

FIG. 15 is a template, generally indicated at 520, for forming another box-shaped object, in this case a “Chinese take-out” box from a medium cut, scored and folded as designated by the template 520. Again, each of the channels for cutting is designated with a “C” and each of the channels for scoring with the scoring tool is indicated with an “F” for fold. Once cut and scored, the box can be assembled by folding along each line that has been scored and inserting the tab cut with the channel 522 into the slot cut with channel 524.

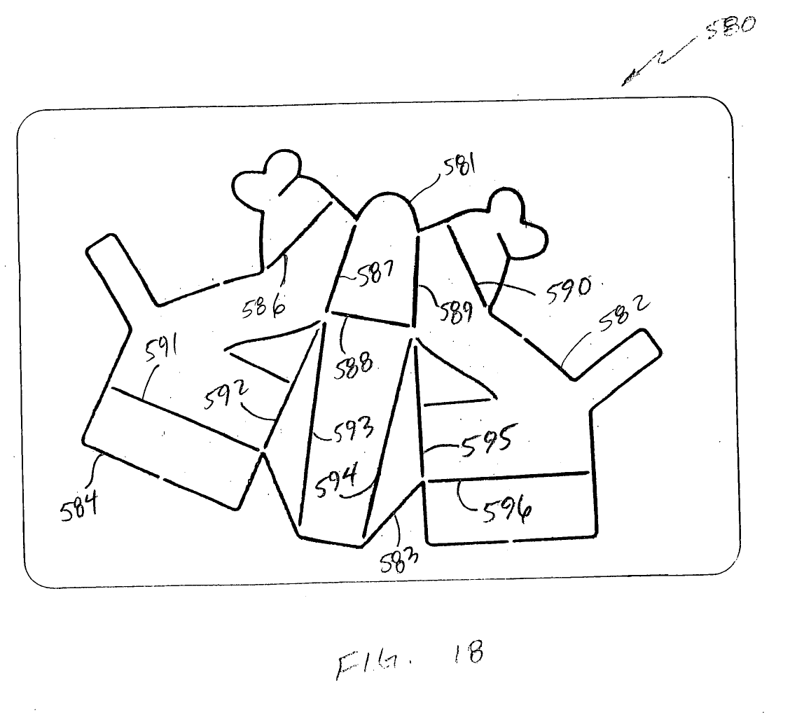

FIG. 16 illustrates a template 540 that is configured to form three different sizes of pillow boxes. By cutting along the outer channels 541 and 542 and scoring along the inner channels 543-548, a pillow box of a particular size can be formed by folding the material that has been cut along the scored lines and attaching the tab portions formed by scoring channels 543 and 546 together.

FIG. 17 illustrates a template, generally indicated at 560, for forming a boot-shaped box or three-dimensional card. Similar to other embodiments herein, by cutting along the outer channels 561-565 to form the outer shape of the box and scoring along the inner channels 569-579 and folding the material along such scores, a boot-shaped box or card can be formed.

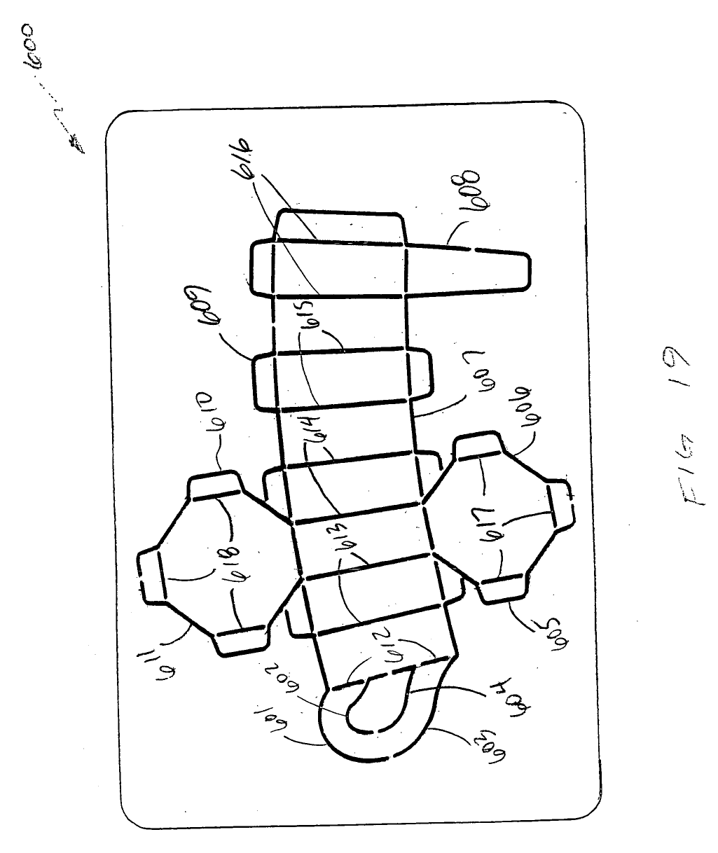

FIG. 18 illustrates a template, generally indicated at 580, for forming a shoe-shaped box or three-dimensional card. Similar to other embodiments herein, by cutting along the outer channels 581-584, scoring along the inner channels 586-596, folding along the scores created by the scoring tool and attaching any tabs formed by cutting and scoring, a shoe-shaped box or card can be formed.

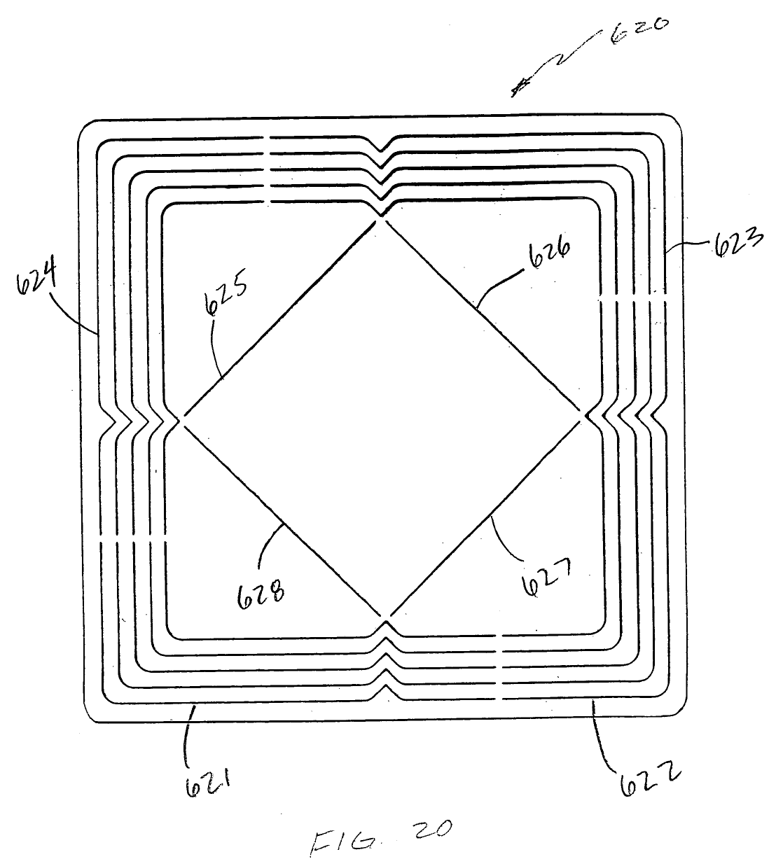

FIG. 19 illustrates a template, generally indicated at 600, for forming a coffee cup shaped box from a material that is cut and scored through the channels of the template 600. Similar to other embodiments herein, by cutting along select cutting channels 601-611 and scoring along select scoring channels 612-617 and folding along the scored lines, a coffee cup shaped box can be formed.

FIG. 20 illustrates a template, generally indicated at 620, for forming a square envelope. The template is configured for allowing a user to form five different sizes of such a square envelope with each smaller sized nested within the next larger size. Similar to other embodiments herein, by cutting a material in sheet form along the outer channels for a particular sized envelope, such as outer channels 621-624 and scoring the material along scoring channels 625, 626, 627 and 628 without moving the material that has been cut while scoring, and folding along the scores created with the scoring tool of the present invention and the template 620, a square envelope can be formed.

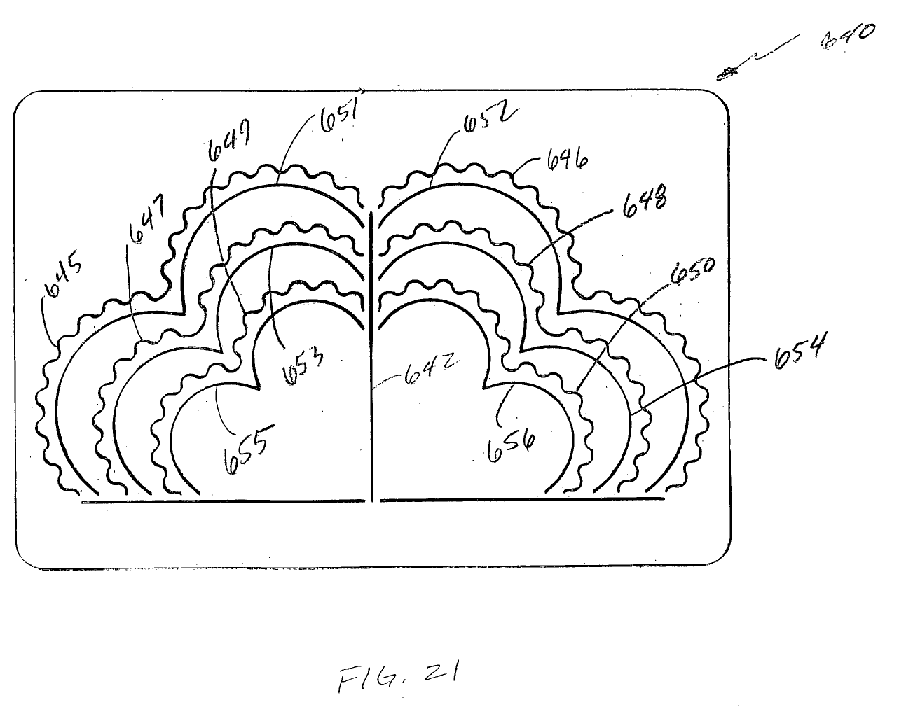

FIG. 21 illustrates a template, generally indicated at 640, for forming a heart-shaped card. The template is configured for allowing a user to form three different sized cards. In addition, the cards can be formed with a scalloped outer edge or a smooth outer edge depending upon the channel, 645-650 or 651-656, respectively, used to cut the top outer edges. By scoring along the inner channel 642 and folding along the score, a heart shaped card can be formed.

Of course, the templates are not limited to the specific designs shown in the drawings, and other designs obvious to persons skilled in the art may be used in making templates according to this invention. While the methods and apparatus of the present invention have been described with reference to certain embodiments, it is contemplated that upon review of the present invention, those of skill in the art will appreciate that various modifications and combinations may be made to the present embodiments without departing from the spirit and scope of the invention as recited in the claims. The claims provided herein are intended to cover such modifications and combinations and all equivalents thereof. Reference herein to specific details of the illustrated embodiments is by way of example and not by way of limitation.

What is claimed is:

1. An apparatus for forming a three-dimensional object from a material in sheet form, comprising;
a scoring tool having a freely rotatable scoring blade, said scoring blade having a curved distal surface for contacting a medium;
a cutting tool having a freely rotatable cutting blade; and
a template having a plurality of channels formed therein, said plurality of channels including at least one first channel for receiving said scoring blade and at least one second channel for receiving said cutting blade.

2. The apparatus of claim 1, wherein said scoring tool comprises a handle and a scoring member freely rotatably coupled thereto.

3. The apparatus of claim 2, wherein said cutting tool comprises a cutting blade freely rotatably coupled thereto.

4. The apparatus of claim 3, wherein said scoring tool comprises a scoring cartridge and said cutting tool comprises a cutting cartridge, said scoring cartridge and said cutting cartridge being interchangeably coupled to said handle.

5. The apparatus of claim 1, wherein said at least one first channel and said at least one second channel have substantially similar channel widths and said scoring blade and said cutting blade have substantially similar blade widths, said blade widths being similar to and smaller than the channel widths.

6. The apparatus of claim 1, wherein said template is configured to form a three-dimensional object from a sheet of material that is cut and scored with the cutting tool and scoring tool through the plurality of channels of the template.

7. The apparatus of claim 6, wherein said three-dimensional object is comprised of one of a box, a pocket and a card.

8. The apparatus of claim 1, wherein said scoring blade is formed from a flat metal segment having rounded first and second edges forming said curved distal surface.

9. The apparatus of claim 8, wherein said first and second edges are radiused to prevent the scoring blade from cutting a material to be scored.

10. An apparatus for forming a three-dimensional object from
a material in sheet form, comprising;
a scoring tool having a freely rotatable scoring blade, said scoring blade having a curved distal surface for contacting a medium;
said scoring blade having a width for being received within and guided by a channel of a template for scoring a medium placed beneath the template.

11. The apparatus of claim 10, wherein said template comprises a plurality of channels formed therein, said plurality of channels including at least one first channel for receiving said scoring blade and at least one second channel for receiving a cutting blade.

12. The apparatus of claim 10, wherein said scoring tool comprises a handle, said scoring blade being rotatably retained relative to said handle with said scoring blade being exposed from an end of said handle.

13. The apparatus of claim 10, wherein said scoring tool comprises a retaining cap having an annular bore extending there through for receiving and retaining said scoring blade.

14. The apparatus of claim 12, wherein said retaining cap comprises a cylindrically shaped distal end for inserting into a select channel of said template and for guiding said scoring blade along said channel.

15. The apparatus of claim 14, wherein said scoring tool comprises a scoring cartridge retained within said retaining cap.

16. The apparatus of claim 15, further comprising a cutting cartridge having a cutting blade and interchangeable with said scoring cartridge within said retaining cap.

17. The apparatus of claim 16, wherein said template includes at least one first channel for scoring and at least one second channel for cutting having substantially similar channel widths and said scoring blade and said cutting blade have substantially similar blade widths, said blade widths being similar to and smaller than the channel widths.

18. The apparatus of claim 17, wherein said template is configured to form a three-dimensional object from a sheet of material that is cut and scored with the cutting blade and scoring blade through the plurality of channels of the template.

19. The apparatus of claim 18, wherein said three-dimensional object is comprised of one of a box, a pocket and a card.

20. The apparatus of claim 10, wherein said scoring blade is formed from a flat metal segment having rounded first and second edges forming said curved distal surface.

21. The apparatus of claim 20, wherein said first and second edges are radiused to prevent the scoring blade from cutting a material to be scored.

22. A method of forming a three-dimensional object from a material in sheet form, comprising;
providing a scoring tool having a freely rotatable scoring blade;
providing a cutting tool having a freely rotatable cutting blade; and
providing a template having a plurality of channels formed therein, said plurality of channels including at least one first channel for receiving said scoring blade and at least one second channel for receiving said cutting blade;
placing a sheet of material beneath said template;
inserting said scoring blade into said at least one first channel of said template, pressing said scoring blade against said sheet and gliding said scoring blade through said at least one first channel to create at least one score in said sheet;
inserting said cutting blade into said at least one first channel of said template, pressing said cutting blade against said sheet and gliding said scoring blade through said at least one first channel to cut said sheet into a cut shape defined by said at least one first channel.

23. The method of claim 22, further including, folding said sheet along said at least one score to form a three-dimensional object from said cut shape of said sheet.

24. The method of claim 22, wherein said three-dimensional object is selected from one of a box, a pocket and a folded card.

25. The method of claim 22, further comprising providing said scoring blade in a scoring cartridge.

26. The method of claim 25, further comprising providing said cutting blade in a cutting cartridge.

27. The method of claim 26, further comprising providing a handle configured for receiving and retaining one of said scoring cartridge and said cutting cartridge and wherein said scoring cartridge and cutting cartridge are provided to be interchangeable.
